(19) United States
(12) Patent Application Publication
(10) Pub. No.: US 2001/0034683 A1
(43) Pub. Date: Oct. 25, 2001

(54) Method and system for online investment contests

(76) Inventor: Wei Ren, Berkeley, CA (US)

Correspondence Address: WEI REN, Wevest .Com, Inc., 1056 GRIZZLY PEAK BLVD, Berkeley, CA, 94708, US

(21) Appl. No.: 09/796,501

(22) Filed: Feb. 28, 2001

Related U.S. Application Data
(60) Provisional application No. 60/185,243, filed on Feb. 28, 2000.

(51) Int. Cl. G06F 17/60

(52) U.S. Cl. 705/35

(57) ABSTRACT

A method and a system for a distributed electronic system in which remotely located contestants participate in investment contests through input/output devices connected to a central controller which manages contests and stores contest data. The method includes steps: 1) that rate and rank participants, taking into consideration of factors including investment returns, risk level, investment styles, and the duration of their participation, and their levels of knowledge in investment, finance and specific industries; 2) that runs the contests continuously such that it allows contestants to begin, withdraw from, and resume the contest anytime they choose, with their ratings being updated continuously; 3) that awards prizes and titles according to these ratings and other factors such as age; 4) that separate contestants with different skill levels according to these ratings into different leagues. The system includes software and hardware to implement the method. Contestants can participate either through Internet or other media such as phone, fax, and mail.

### CROSS-REFERENCES TO RELATED APPLICATIONS

This application is entitled to the benefit of Provisional patent application Ser. No. 60/185,243, filed Feb. 28, 2000.

### BACKGROUND-FIELD OF INVENTION

This invention relates to investment contests, specifically to improved online investment contests and an improved method for rating and ranking contest participants.

### BACKGROUND-DESCRIPTION OF PRIOR ART

Investment contests have been around for a long time. More recently, investment contests have become more popular on the World Wide Web. Many online operators such as Yahoo and E*Trade offer investment contests. After investigation of prior arts related to investment contests, it is observed that all the existing investment contests operate with the following characteristics: 1) investment contests run for a fixed period of time, typically a month to half a year. 2) At the beginning of the contest period, contestants enter the contest by registering in a central database and starting a virtual portfolio, i.e. portfolio of securities such as stocks and options, bought with fantasy money. The entrance to the contest is either free or subject to a small fee. 3) Throughout the contest period, contestants can do simulated trading of their virtual portfolios. 4) At the end of the period, the investment returns of all contestants during the entire pre-determined contest period are used to rank the contestants and award prizes.

Consequently, all the existing investment contests have the following drawbacks. 1) The contestants have to commence their plays at the same time, and if they miss the beginning date, then they may have to wait for the next round. 2) Existing arts do not have a method to rank their performance based on long-term track record that extend over more than one contest period, because contestants may have different duration of participation. For example, one contestant has been playing for one year, another has been playing for the last three months, and yet another played last year, then stopped for three months, and now is back to the contest for the last two months. Consequently, long-term track record cannot be made of effective use. With existing contests typically lasting a short period of time and unable to use long-term record, common sense argues that the resulting ranking is dictated more by chance than by skills. 3) Without effective ranking based on long-term track record, all the contestants, regardless of their experiences and investment styles, compete solely based on short-term investment returns. 4) Because only short-term record is used for ranking, the performance ranking does not take into the consideration of risk level in contestants' portfolios. 5) Because the performance ranking and corresponding prizes are purely based on the return during the current period, contestants take a short-term view towards the investment process. For example, the contestants are likely to take an all or nothing approach to picking stocks. 5) Without effective ranking, the contestants cannot derive much pride from participating and establishing a long-term track record. 6) The existing contests do not rate the performance of after-tax returns after subtracting long-term and short-term capital gain taxes 7) The existing contests rely only on past portfolio data and do not take into consideration of contestants' different levels of experienced and knowledge in relevant areas such as investment experience, financial analysis, accounting, industry-specific knowledge, etc.

In a related development, it is worth pointing out that there are several ways to rate and rank mutual funds, such as the Morning Star system and the Sharpe ratio. They do take into consideration of risk, in addition to investment performance. For example, in the Morningstar system, the funds are typically ranked according to their performance in a particular fixed period of time, such as past 3 years, or past 5 years. However these systems cannot strictly rank, say, a fund whose performance since inception 5 years ago is 20% annual return vs. another fund whose performance since inception 2 years ago is 40% annual return. In this case, only their performances over the past two years can be directly compared, without taking into consideration of the three-year operating history of the first fund prior to two years ago.

### OBJECTS AND ADVANTAGES

It is accordingly an object of the present invention to be able to rate contestants with different durations of participations that take into consideration of investment returns, risk levels and the durations of participation. For example, using the method of the present invention, a contestant whose investment performance is 2% above the appropriate market index over 1 year 3 month and 5 days can be compared with a contestant whose investment performance is 2% above the same market index over 5 months, and can be also compared with a contestant whose investment performance is 5% above the same market index over 4 months.

It is another object of the present invention to allow contestants to begin and to withdraw from and to resume the contests anytime they choose, with their ratings being continuously updated, thus, making the contest much more accessible and the contestants more likely to return.

It is another object of the present invention to allow prizes to be given based on long-term record, thus, making the contest more reflective of contestants' investment skills. It is another object of the present invention to award appropriate titles using this rating, just as karate students are given different colors of belts according to their skill levels.

It is another object of the present invention to separate contestants into different leagues according to their rankings based on long-term track record.

It is another object of the present invention to also rank the contestants based on investment return as well as risk.

It is another object of the present invention to rank both before-tax and after-tax return performance.

It is another object of the present invention to take into consideration of contestants' sophistication in relevant areas such as investment experience, financial analysis, specific knowledge in industries for which the contest league is targeted. For example, the contest league may be for stocks in the software industry only, and the knowledge of the software industry may be incorporated in ranking contestants.

### DESCRIPTION OF THE INVENTION

Central to delivering the above objects and advantages is a method provided by this invention which rate investment contest participants by computing a numerical rating for each contestant at the end of each performance measurement period, e.g. a day. This numerical rating takes into consideration of factors including investment returns, risk level, investment styles, and the duration of their participation, and their levels of knowledge in investment, finance and specific industries. The rankings of contestants at the end of each performance measurement period are then determined by sorting the contestants' numerical ratings at that time.

This method is based on the following steps: Time-Discretization, Iterative Updating, Intelligent Initialization, Performance Normalization, Memory-Forgetting, Risk Adjustment, and Performance Extrapolation. Each of these steps is explained further below. Not all of steps need to be employed at the same time for a particular rating.

### Time-Discretization

For performance ratings, the time is discretized into fixed period, called performance-measurement period, such as a day, a week, or a month.

### Iterative Updating

To avoid computing the performance ratings based on the entire trading history, the ratings are preferably updated iteratively from one period to next, i.e., the rating for the present time period is computed from the rating for the previous period and the portfolio record for the present period.

### Intelligent Initialization

The rating for a beginning contestant will normally be set to zero. Alternatively, the initial value of the rating can also be set at some non-zero value so as to capture the different levels of sophistication of contestants in relevant areas such as fundamental investment analysis and industry-specific knowledge. A preferred way to accomplish this is to have contestants take a test on the web before beginning the contest. The test can contain suitably designed multiple-choice questions. The contestants are then assigned different initial ratings based on their test scores.

### Performance Normalization

In order to have meaningful and fair comparisons, it is preferable to “normalize” the investment performance for a particular period by an appropriate market index or average performance. Mathematically, this means either dividing or subtracting from a given performance by the market index or the average performance of all contestants during the same period.

### Memory-Forgetting

The numerical performance ratings on the one hand summarize the past performance, and on the other hand may convey certain predictions about future performance. It can be argued that more recent performance has more to do with future performance than performance of long time ago. Thus, it may be preferable to discount the past rating in the iterative updating process.

### Performance Extrapolation

When a contestant starts the contest in the middle of a performance-measurement period, his performance for the first part of the period for which he did not participate may be extrapolated by a market index or the average performance. In addition, if a contestant temporarily withdraws from the contest for several periods, his performance during these periods may be replaced by the market index or the average performance.

### Risk Adjustment

One way to take into account the risk of a portfolio in addition to investment return is to use the Risk-Adjusted Return (RAR), computed by subtracting a risk-dependent factor from the total investment return. There are a number of ways to measure risk, for example, a popular one being the variance of the investment return. The measure of risks and the computation of RAR are familiar to anyone skilled in the existing arts of measuring investment performance.

Specific embodiments of the method incorporating these steps are described below, in the form of iterative algorithms. These algorithms can be implemented in computers that serve as the central controller and using almost any computer language, for example SQL language, by anyone skilled in the engineering of computer programming.

Let the rating for a contestant at the end of period k be Rₖ, k=0, 1, 2, . . . where 0^{th} period corresponds to the period before the contestant begins his entry in the contest. Let the return (either before tax or after tax) for the contestant's virtual portfolio for the duration of kth period be rₖ (i.e., the cumulative value of $1 invested at the beginning of the period is 1+rₖ at the end of the period, either before tax or after tax). Let the corresponding market index or the average return for the duration of kth period be mₖ (correspondingly before tax or after tax)

Depending on different combinations of the above principles, the present invention provides various numerical ratings. Several preferred embodiments are as follows.

1) Set R₀=0. Update Rₖ as follows: Rₖ=aRₖ₁+log((1+rₖ)(1+m)), k=1, 2, . . . where a is the memory-forgetting factor chosen between 0 and 1, which determines the rate at which the past performance is discounted. A typical choice of the memory-forgetting factor would be 0.95. In another embodiment, the forgetting factor can be selected in more elaborate ways, for example, by using the well known least squares method to optimize the predictive ability of the rating.

Or,

2) Set R₀=0. Update Rₖ as follows: Rₖ=aRₖ₁+(rₖ−mₖ), k=1, 2, . . . where a is the memory-forgetting factor chosen between 0 and 1.

Or,

3) Set R₀=0. Update Rₖ as follows: Rₖ=(Rₖ₋₁)^{a}(1+rₖ)/(1+mₖ),k=1, 2, where a is the memory-forgetting factor chosen between 0 and 1.

Or,

4) In all the above, the return rₖ is replaced by a risk adjusted return of the virtual portfolio and mₖ replaced by a corresponding risk-adjusted return of the market portfolio or the average of the risk-adjusted returns of all contestants.

Or,

5) In all the above, set R₀ to some non-zero value, determined by contestants' scores in some test, e.g. multiple choice test, prescribed by the contest organizer to test all contestants' investment and/or industry-specific knowledge. Accordingly, contestants with above-average scores would receive some initial positive ratings.

Several enhanced investment contests are made possible by the rating method described above.

In the preferred embodiment, all contestants participate in the contest by joining one of the many leagues. Each league may have different rules for investment, eligibility, award, ratings, etc. For example, one league may be free, while another is not free; or one league only allows stocks with capitalization exceeding $10 billions; or one league account for taxes, while another does not; or one league only accepts contestants with rankings in the top 20% percentile, etc.

Each contestant initiates his entry to the contest through his personal computers or other input/output devices that are connected with the central controller, which manages the contest. He first establishes his identity in the central controller through 1) user name/password or 2) biometric identifications or 3) public/private encrypted keys 4) or combinations thereof.

The contestant can then choose to participate in the contest by choosing a particular league that is open and for which he is eligible. Through his input/output device, which is connected with the central controller, he can then choose and update his virtual portfolio according to the rules of the league. Associated with his identity is a record in the database located on the central controller, which contains all the virtual investment portfolios he has ever chosen, and his entire trading history, and leagues he has been in, and his numerical ratings, which are initialized and updated according to the steps described later. Note that a contestant can be rated and ranked according to several ratings, for example, some take into consideration of taxes, while others do not, and some take into consideration of risks, while others do not. Based on a particular numerical rating, he is ranked relative to other contestants and receives prizes or titles as appropriate at fixed time instant or in response to special achievements. He may choose to temporarily withdraw from the contest, at which point his record is kept and his numerical ratings and titles may still be updated as time progresses.

In the preferred embodiment above, a contestant is allowed to participate in only one league at any given time. In another embodiment, a contestant is allowed to participate in more than one league at any given time. In this case, he is essentially assigned a different identity and a corresponding set of ratings for each league he participates.

In yet another embodiment, a contestant is allowed to participate in more than one league at any given time. But he maintains only one identity and one set of ratings. The ratings are computed using the average of his performances in all leagues he is in.

I claim:

1. A method for rating and ranking participants in an online investment contest, comprising the steps of:
a. providing a central controller to store all data of said contest, including contestants' profiles, user IDs, passwords, and portfolios,
b. providing a character input/output means which is connected electronically to said central controller to allow each of said participants to input desired trading instructions for his portfolio, which are then transmitted to said central controller to update his portfolio data
c. determining a time unit, e.g. a day, as a performance measurement period,
d. computing and storing in said central controller the values of portfolios of said participants at the end of each said performance period,
e. computing and storing in said central controller the values of a numerical rating for each of said participants at the end of each said performance period, comprising the steps of
i. setting the value of said numerical rating at zero at the time of said participant enters said contest,
ii. updating the value of said rating according to one of the iterative algorithms detailed earlier in the description of the invention.
